(19) United States
(12) Patent Application Publication
(10) Pub. No.: US 2024/0396080 A1
(43) Pub. Date: Nov. 28, 2024

(54) Solid Electrolyte Particle

(71) Applicant: TOYOTA JIDOSHA KABUSHIKI KAISHA, Toyota-shi Aichi-ken (JP)

(72) Inventor: Yusuke SHIMO, Sunto-gun Shizuoka-ken (JP)

(73) Assignee: TOYOTA JIDOSHA KABUSHIKI KAISHA, Toyota-shi Aichi-ken (JP)

(21) Appl. No.: 18/672,418

(22) Filed: May 23, 2024

(30) Foreign Application Priority Data
May 26, 2023 (JP) 2023-086797

(51) Int. Cl. H01M 10/0562

(52) U.S. Cl. CPC H01M 10/0562; H01M 2300/0068

(57) ABSTRACT

A solid electrolyte particle include Li, Ge, P, and S. The solid electrolyte particle satisfies relationships of “0.20≤I_{B}/I_{A}≤0.35” and “0.30≤I_{C}/I_{A}≤0.45”. I_{A}, I_{B}, and I_{C} each indicate a peak height in an X-ray diffraction spectrum measured using a CuKα ray as an X-ray source. I_{A} indicates a peak height at a diffraction angle of 29.4±0.5°. I_{B} indicates a peak height at a diffraction angle of 41.4±0.5°. I_{C} indicates a peak height at a diffraction angle of 47.3±0.5°.

### CROSS REFERENCE TO RELATED APPLICATIONS

This nonprovisional application is based on Japanese Patent Application No. 2023-086797 filed on May 26, 2023 with the Japan Patent Office, the entire contents of which are hereby incorporated by reference.

### BACKGROUND

### Field

The present disclosure relates to solid electrolyte particles.

### Description of the Background Art

WO 2017/155119 discloses a sulfide solid electrolyte.

### SUMMARY

A solid electrolyte is a key material of an all-solid-state battery. Conventionally, a sulfide solid electrolyte including Li, P, and S has been developed. The sulfide solid electrolyte can have a high ionic conductivity on the order of 10⁻³ S/cm. However, the sulfide solid electrolyte tends to have a low oxidation resistance. When the sulfide solid electrolyte undergoes oxidative decomposition, polysulfide may be formed. The formation of polysulfide can lead to decreased ionic conductivity.

A positive electrode has a high potential. In the positive electrode, when the sulfide solid electrolyte undergoes oxidative decomposition, a resistance layer (polysulfide) may be formed at an interface between a positive electrode active material and the sulfide solid electrolyte, for example. The resistance layer can have an ionic conductivity of 10⁻¹⁰ S/cm or less. With the formation of the resistance layer, performance degradation of the all-solid-state battery may be promoted.

An object of the present disclosure is to improve oxidation resistance.

1. A solid electrolyte particle according to one aspect of the present disclosure includes the following configuration. The solid electrolyte particle includes Li, Ge, P, and S. The solid electrolyte particle satisfies relationships of the following formulas (1) and (2).

$$0.2 \leq {I}_{B} / {I}_{A} \leq 0 \text{.35} \qquad ( 1 )$$

$$0.3 \leq {I}_{C} / {I}_{A} \leq 0 \text{.45} \qquad ( 2 )$$

In the above formulas (1) and (2), I_{A}, I_{B}, and I_{C} each indicate a peak height in an X-ray diffraction spectrum measured using a CuKα ray as an X-ray source. I_{A} indicates a peak height at a diffraction angle of 29.4±0.5°. I_{B} indicates a peak height at a diffraction angle of 41.4±0.5°. I_{C} indicates a peak height at a diffraction angle of 47.3±0.5°.

In the X-ray diffraction (XRD) spectrum of the solid electrolyte particle, the peak group appearing at diffraction angles (2θ)=29.4±0.5°, 41.4±0.5°, and 47.3±0.5° are considered to belong to an LGPS-type crystal phase. The LGPS-type crystal phase may have a high ionic conductivity. A peak height ratio (I_{B}/I_{A}, I_{C}/I_{A}) is an index of crystallinity. A smaller peak height ratio (I_{B}/I_{A}, I_{C}/I_{A}) indicates a lower crystallinity. According to a new finding of the present disclosure, an appropriately low crystallinity is expected to lead to an improvement in oxidation resistance. However, when the crystallinity is decreased excessively, the oxidation resistance may be decreased conversely. That is, when the relationships of the above formulas (1) and (2) are satisfied, the improvement in oxidation resistance is expected.

2. The solid electrolyte particle according to “1” may include the following configuration. In the X-ray diffraction spectrum, the peak at a diffraction angle of 29.4±0.5° has a full width at half maximum of 0.15° or less.

When the peak at a diffraction angle of 29.4±0.5° has a full width at half maximum (FWHM) of 0.15° or less, high ionic conductivity and oxidation resistance are both expected to be achieved.

3. The solid electrolyte particle according to “1” or “2” may include the following configuration. The solid electrolyte particle further satisfies a relationship of the following formula (3).

$$1.2 \leq {I}_{E} / {I}_{D} \qquad ( 3 )$$

In the formula (3), I_{D} and I_{E} each indicate a peak height in a Raman spectrum. I_{D} indicates a peak height at a Raman shift of 420±10 cm⁻¹. I_{E} indicates a peak height at a Raman shift of 360±10 cm⁻¹. The Raman spectrum has a shoulder peak at a Raman shift of 388±3 cm⁻¹.

In the Raman spectrum of the solid electrolyte particle, the shoulder peak appearing at a Raman shift of 388±3 cm⁻¹ is considered to result from an impurity phase such as Li₂S. It is considered that the impurity phase is generated by oxidative decomposition of the LGPS-type crystal phase. That is, the impurity phase is a cause of decreased crystallinity. When the solid electrolyte particle satisfies the relationship of the above formula (3), it is considered that the crystallinity in bulk is maintained. Since the impurity phase is locally introduced while the crystallinity in bulk is maintained, high ionic conductivity and oxidation resistance are both expected to be achieved.

4. The solid electrolyte particle according to any one of “1” to “3” may include the following configuration. The solid electrolyte particle includes a core portion and a shell portion. The shell portion covers a periphery of the core portion. The core portion includes an LGPS-type crystal phase. The shell portion includes an amorphous phase. The core portion has an ionic conductivity of 10×10⁻³ S/cm or more. The shell portion has an ionic conductivity of 1×10⁻³ S/cm or less.

For example, the crystallinity may be locally decreased in the outermost surface of the particle. The solid electrolyte particle may have, for example, a core-shell structure. The LGPS-type crystal phase tends to have high ionic conductivity and low oxidation resistance. The amorphous phase tends to have low ionic conductivity and high oxidation resistance. Since the core portion includes the LGPS-type crystal phase and the shell portion (outermost surface) includes the amorphous phase, high ionic conductivity and oxidation resistance are both expected to be achieved.

5. The solid electrolyte particle according to “4” may include, for example, the following configuration. The shell portion has a thickness of 100 nm or less.

Since the shell portion (amorphous phase) has a thickness of 100 nm, high ionic conductivity and oxidation resistance are both expected to be achieved.

Hereinafter, an embodiment of the present disclosure (hereinafter, also simply referred to as “the present embodiment”) and an example of the present disclosure (hereinafter, also simply referred to as “the present example”) will be described. It should be noted that the present embodiment and the present example do not limit the technical scope of the present disclosure. The present embodiment and the present examples are illustrative in any respects. The present embodiment and the present examples are non-restrictive. The technical scope of the present disclosure includes any modifications within the scope and meaning equivalent to the terms of the claims. For example, it is initially expected to freely extract configurations from the present embodiment and the present example and combine them freely.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an example of an XRD spectrum.

FIG. 2 is an example of a Raman spectrum.

FIG. 3 is an example of a cyclic voltammogram.

FIG. 4 is a conceptual diagram of a core-shell structure.

FIG. 5 is a schematic flowchart of a method for producing solid electrolyte particles according to the present embodiment.

FIG. 6 is a table showing experimental results.

### DESCRIPTION OF THE EMBODIMENTS

### Terms

The “XRD spectrum” is measured by a powder XRD method. The measurement conditions are as follows. However, the measuring device is merely an example, and an equivalent device may be used.

Measuring Measurement: product name “RINT-2000”, manufactured by Rigaku.

X-Ray Source: Cu—Kα ray

Angular Range: 2θ=10 to 60°

The peak height ratio (I_{B}/I_{A}, I_{C}/I_{A}) is determined by the following procedure. Background is removed from the raw data of the XRD spectra. After removing the background, the XRD spectrum is normalized by setting the height of the peak appearing at the diffraction angle of 29.4±0.5° to “1”. In the XRD spectrum after normalization, the peak height at a diffraction angle of 41.4±0.5° is regarded as the peak height ratio (I_{B}/I_{A}). Similarly, in the XRD spectrum after normalization, the peak height at a diffraction angle of 47.3±0.5° is regarded as the peak height ratio (I_{C}/I_{A}). For example, when a plurality of peaks are present in a range of 29.4±0.5°, the height of the highest peak is measured. Further, the FWHM of the peak at a diffraction angle of 29.4±0.5° is measured.

The Raman spectrum is measured by Raman spectroscopy. The measurement conditions are as follows. However, the measuring device is merely an example, and an equivalent device may be used.

Measuring Measurement: product name “LabRAM HR”, manufactured by Horiba Corp.

Laser wavelength: 532 nm

Grating: 1200

Wavenumber Range: 200 to 2000 cm⁻¹

The peak height ratio (I_{E}/I_{D}) is determined by the following procedure. The average value of the Raman intensity in the range of 460 to 500 cm⁻¹ is regarded as the reference intensity. The difference between the Raman intensity of the peak top and the reference intensity at the Raman shift of 420±10 cm⁻¹ is regarded as the peak height (I_{D}). The difference between the Raman intensity of the peak top and the reference intensity at the Raman shift of 360±10 cm⁻¹ is regarded as the peak height (I_{E}). The peak height ratio (I_{E}/I_{D}) is obtained by dividing the peak height (I_{E}) by the peak height (I_{D}).

The “LGPS-type crystal phase” indicates a crystal phase having an LGPS-type structure. The LGPS-type structure includes a three-dimensional skeleton. The three-dimensional skeleton includes a plurality of one-dimensional chains. Each one-dimensional chain is formed by one-dimensionally connecting a (Ge_{0.5}P_{0.5})S₄ tetrahedron and a LiS₆ octahedron while sharing a ridge. Two adjacent one-dimensional strands are linked through a PS₄ tetrahedron. In the LGPS-type structure, the P atom may occupy the 4d site and the 2b site. The 4d site constitutes a one-dimensional chain. The 2b site constitutes a linking portion linking the one-dimensional chains. The 4d site may be occupied by a Ge atom and a P atom. In the 4d site, the molar ratio is “Ge/P=1/1”. The 2b site may be occupied only by P atoms. The XRD spectrum of the LGPS-type crystal phase has peaks at diffraction angles (2θ)=29.4±0.5°, 41.4±0.5°, and 47.3±0.5°.

Numerical ranges such as “m to n %” include upper and lower limits unless otherwise specified. That is, “m to n %” indicates a numerical range of “m % or more and n % or less”. The term “m % or more and n % or less” includes “more than m % and less than n %”.

Descriptions of “comprising,” “including,” “have” and variations thereof (e.g., “being composed of”, etc.) are open-ended terms. The term open-ended may or may not further include additional elements in addition to the stated elements. The term “consisting of” is a closed term. However, even closed terms do not exclude additional elements that are normally associated with impurities or that are unrelated to the technology of the present disclosure. The term “consisting essentially of” is a semi-closed term. The term semi-closed permits the addition of elements that do not materially affect the basic and novel characteristics of the technology of the present disclosure.

Elements expressed in the singular also include the plural unless specifically stated otherwise. For example, “particles” include not only “one particle” but also “a plurality of particles (particle groups)” and “aggregation of particles (powder)”.

The stoichiometric formula represents a representative example of a compound. The compound may have a non-stoichiometric composition. For example, “Al₂O₃” is not limited to a compound having an amount-of-substance ratio (molar ratio) of “Al/O=2/3”. “Al₂O₃” refers to a compound containing Al and O in any amount-of-substance ratio unless otherwise specified. Furthermore, for example, the compound may be doped with a trace element. Part of Al and O may be substituted with another element.

### —Solid Electrolyte Particles—

The solid electrolyte particles are Li ion conductors. The solid electrolyte particles may be for an all-solid-state battery, for example. The solid electrolyte particles may be used, for example, for a positive electrode, a negative electrode, or a separator. The D50 of the solid electrolyte particles may be, for example, 0.01 to 10 μm, 0.01 to 1 μm, or 0.1 to 1 μm. “D50” indicates the particle size at which the integration is 50% in the volume-based particle size distribution (integrated distribution). The particle size distribution may be measured by laser diffraction.

The solid electrolyte particles contain Li (lithium), Ge (germanium), P (phosphorus), and S (sulfur) as chemical components. The solid electrolyte particle may have, for example, a bulk composition represented by the following formula (4).

$${Li}_{10 + x} {Ge}_{1 + x} {P}_{2 - x} {S}_{12} ( 0 \leq x \leq 0.7 ) \qquad ( 4 )$$

In the above formula (4), x may be, for example, 0.5 or less, 0.3 or less, or 0.1 or less.

### —XRD Spectrum—

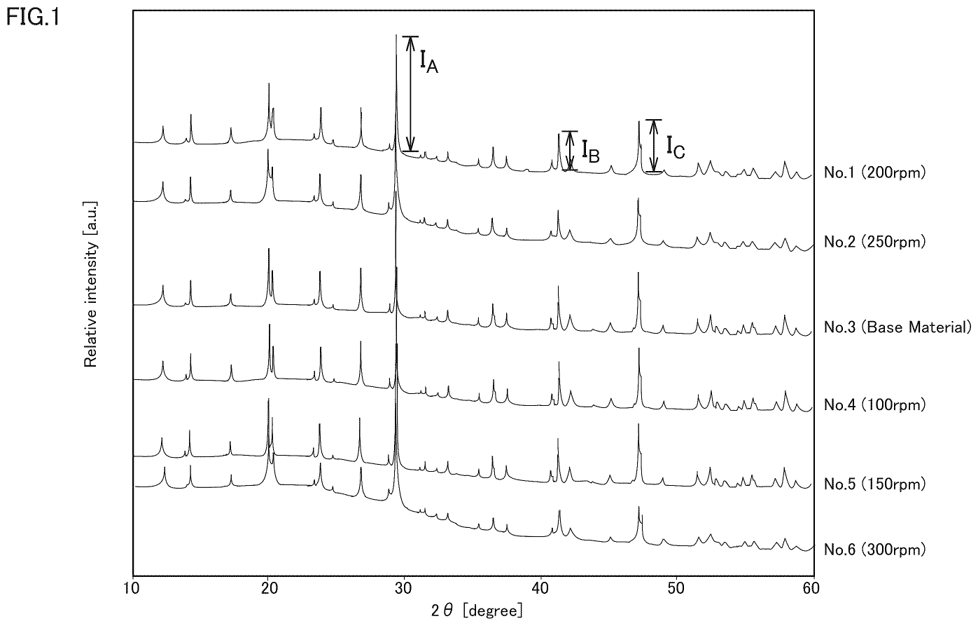

FIG. 1 is an example of an XRD spectrum. The solid electrolyte particles have a specific XRD spectrum. The peak height ratio (I_{B}/I_{A}) is 0.20 to 0.35. In this range, improvement in oxidation resistance is expected. The peak height ratio (I_{B}/I_{A}) may be, for example, 0.31 or less. The peak height ratio (I_{B}/I_{A}) may be, for example, 0.29 or more.

The peak height ratio (I_{C}/I_{A}) is from 0.30 to 0.45. In this range, improvement in oxidation resistance is expected. The peak height ratio (I_{C}/I_{A}) may be, for example, 0.44 or less or 0.43 or less. The peak height ratio (I_{C}/I_{A}) may be, for example, 0.42 or more or 0.43 or more.

The FWHM at the peak at a diffraction angle of 29.4±0.5° may be, for example, 0.15° or less. The FWHM may be, for example, 0.14° or less. The FWHM may be, for example, 0.13° or more.

### —Raman Spectrum—

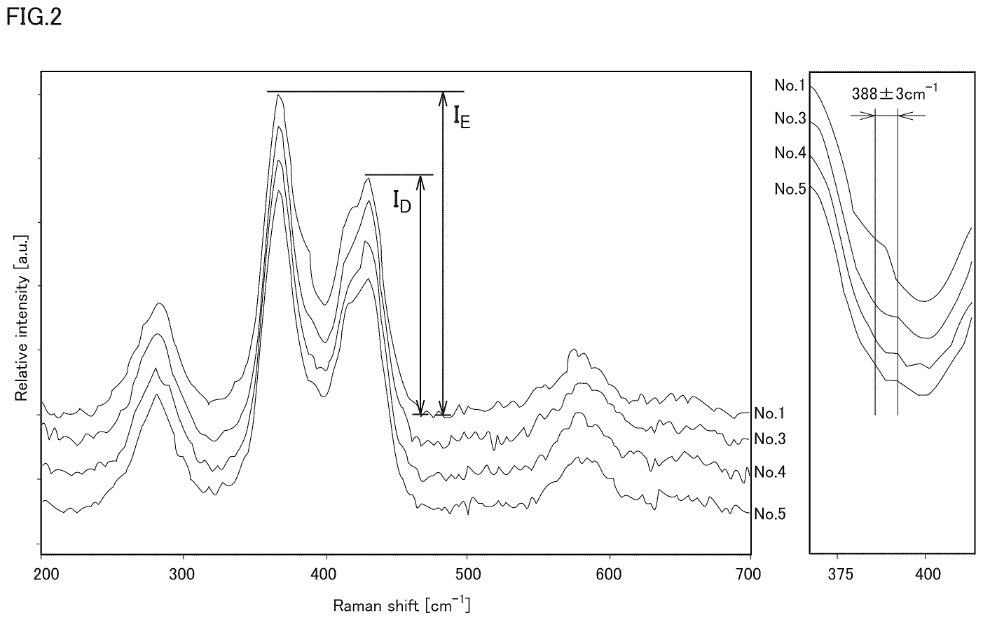

FIG. 2 is an example of a Raman spectrum. The solid electrolyte particles may have a specific Raman spectrum. The Raman spectrum may have a shoulder peak at a Raman shift of 388±3 cm⁻¹. The shoulder peak is considered to be derived from the impurity phase (Li₂S, etc.). The presence of a moderate amount of impurity phase is expected to improve oxidation resistance.

The peak height ratio (I_{E}/I_{D}) may be, for example, 1.2 or more. When the peak height ratio (I_{E}/I_{D}) is 1.2 or more, it is considered that the change in the crystallinity of the bulk is small. Due to the small change in the crystallinity of the bulk, high ionic conductivity is expected. Peak height ratio (I_{E})/I_{D}) may be, for example, 1.30 or more or 1.35 or more. The peak height ratio (I_{E}/I_{D}) may be, for example, 1.40 or less or 1.35 or less.

### —Cyclic Voltammetry—

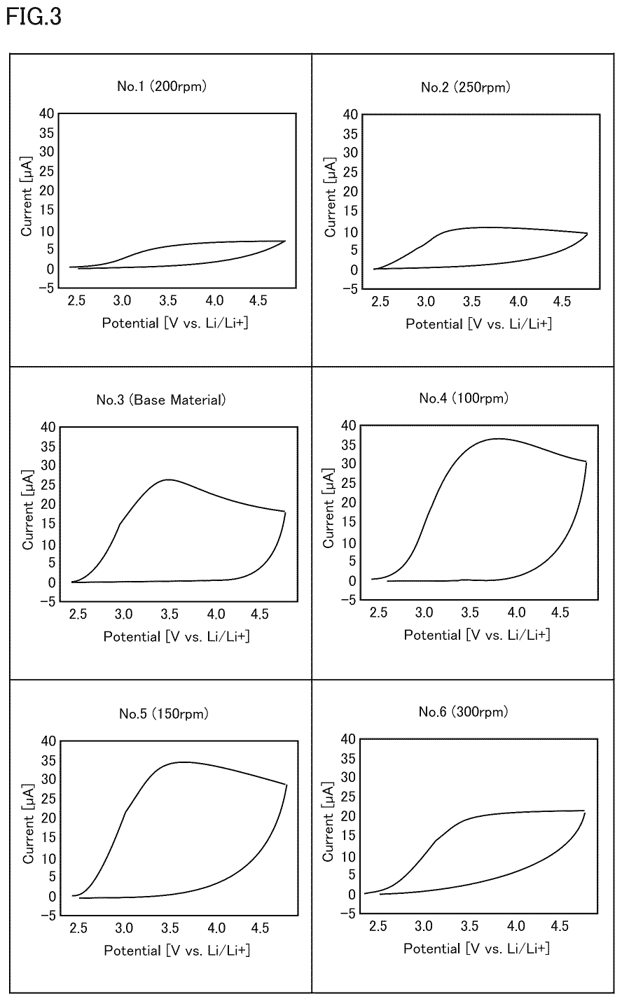

FIG. 3 is an example of a cyclic voltammogram. Oxidation resistance can be assessed by cyclic voltammetry (CV). The smaller the maximum value (hereinafter, it is also referred to as “maximum current”) of the oxidation current in the cyclic voltammogram (current-potential curve), the better the oxidation resistance. The solid electrolyte particles may have a maximum current of 20 μA or less, for example. The maximum current may be, for example, 11 μA or less, or 7 μA or less. The maximum current may be, for example, 1 μA or more, 3 μA or more, or 7 μA or more.

The cyclic voltammogram may have a peak (maximum value) on the oxidation side. The cyclic voltammogram may have no peak on the oxidized side. When there is no peak on the oxidation side, improvement in oxidation resistance is expected.

The CV is measured by a half cell. The half cell includes a working electrode and a counter electrode. The counter electrode is Li metal. The working electrode is prepared by the following procedure. The sample (solid electrolyte particles) is compressed to form a first pellet (powder compact). A mixture is prepared by mixing the sample and vapor-grown carbon fibers (VGCF). The mixing ratio was “sample/VGCF=1/1 (volume ratio)”. The second pellet is formed by compressing the mixture on the base material using the first pellet as the base material. The working electrode is a stack of the first pellet and the second pellet. The second pellet is crimped to the first pellet. It is believed that by including a conductive material (VGCF) in the working electrode, possible oxidation reactions in the actual electrode can be observed.

The CV measurement conditions are as follows. However, the measuring device is merely an example, and an equivalent device may be used.

Measuring Measurement: product name “VMP3”, manufactured by BioLogic.

Sweep rate: 0.1 mV/s

Sweep potential range: 2.5 to 4.8 V (vs. Li/Li⁺)

### —AC Impedance—

The solid electrolyte particles may have high ionic conductivity. The solid electrolyte particles may have an ionic conductivity of, for example, 3.0×10⁻³ S/cm or more. The ionic conductivity may be, for example, 4.5×10⁻³ S/cm or more, or 5.0×10⁻³ S/cm or more. The ionic conductivity may be, for example, 5.5×10⁻³ S/cm or less, or 5.0×10⁻³ S/cm or less.

Ionic conductivity is measured by the AC impedance method. The solid electrolyte particles (powder) are compressed to produce pellets. The pellet is sandwiched between the deactivated electrodes to form a symmetric cell. The deactivated electrode and the solid electrolyte particles have different carrier ions from each other. The deactivated electrode may comprise, for example, stainless steel or the like. In a symmetric cell, ionic conductivity is measured. The measurement conditions are as follows. However, the measuring device is merely an example, and an equivalent device may be used.

Measuring Measurement: product name “VMP3”, manufactured by BioLogic.

Frequency Range: 1 MHz to 0.1 Hz

Applied voltage: 10 mV

Measurement temperature: 25±1° C.

The measured data is plotted on a complex plane to generate a Cole-Cole plot. The resistance is determined from the intersection of the curve and the real axis. The ionic conductivity is determined by the following formula (5).

$$σ = 1 / \{ ( r \times s ) / t \} \qquad ( 5 )$$

σ: ionic conductivity
R: resistance
S: area of working electrode
T: thickness of working electrode

### —Core Shell Structure—

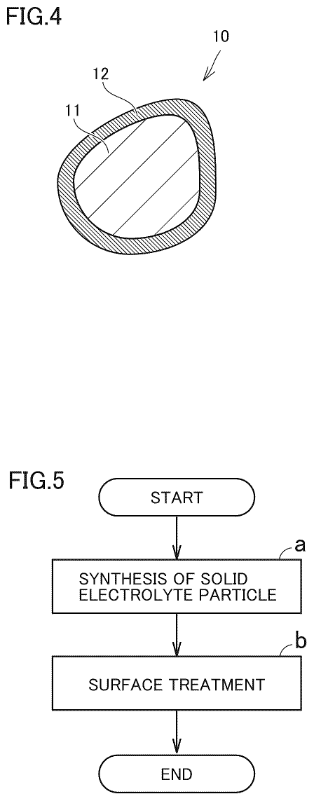

FIG. 4 is a conceptual diagram of a core-shell structure. The solid electrolyte particle 10 may have, for example, a core-shell structure. That is, the solid electrolyte particle 10 may include the core portion 11 and the shell portion 12.

The core portion 11 includes a high ion conductive phase. The core portion 11 may include, for example, an LGPS-type crystal phase. The core portion 11 may have, for example, an ionic conductivity of 10×10⁻³ S/cm or more. The ionic conductivity of the core portion 11 may be, for example, 15×10⁻³ S/cm or more, or 20×10⁻³ S/cm or more. The ionic conductivity of the core portion 11 may be, for example, 20×10⁻³ S/cm or less, or 15×10⁻³ S/cm or less. The core portion 11 may have a Feret diameter of 0.1 to 1 μm, for example. The “Feret diameter” indicates a distance between two farthest points on the contour line of the core portion 11 in the cross-sectional image of the solid electrolyte particle 10.

The shell portion 12 covers the periphery of the core portion 11. The shell portion 12 may cover the entire core portion 11. The shell portion 12 may cover a part of the core portion 11. The shell portion 12 includes a low ion conductive phase. The shell portion 12 may have oxidation resistance. The shell portion 12 may have, for example, lower crystallinity than the core portion 11. The shell portion 12 may include, for example, an amorphous phase. The shell portion 12 may have an ionic conductivity of 1×10⁻³ S/cm or less, for example. The ionic conductivity of the shell portion 12 may be, for example, 0.5×10⁻³ S/cm or less, or 0.1×10⁻³ S/cm or less. The ionic conductivity of the shell portion 12 may be, for example, 0.1×10⁻³ S/cm or more, or 0.5×10⁻³ S/cm or more. The shell portion 12 may have a thickness of, for example, 100 nm or less. The thickness of the shell portion 12 may be, for example, 50 nm or less, or 10 nm or less. The thickness of the shell portion 12 may be, for example, 1 nm or more, 10 nm or more, or 50 nm or more.

### —Method for Producing Solid Electrolyte Particles—

FIG. 5 is a schematic flowchart of a method for producing solid electrolyte particles according to the present embodiment. Hereinafter, the “method for producing solid electrolyte particles according to the present embodiment” may be abbreviated as “the production method”. The production method includes “(a) Synthesis of Solid Electrolyte Particles” and “(b) Surface Treatment”.

### (a) Synthesis of Solid Electrolyte Particles

The production method includes synthesizing solid electrolyte particles. The solid electrolyte particles may be synthesized by, for example, a solid phase reaction. The solid electrolyte particles may be synthesized by, for example, a mechanochemical reaction. The solid electrolyte particles are synthesized to include an LGPS-type crystal phase. For example, Li₂S, P₂S₅ and GeS₂ are mixed in a predetermined formulation to form a mixture. For example, the mixing may be carried out by a planetary ball mill. Mixing may be performed under an Ar atmosphere. By subjecting the mixture to heat treatment (calcination), solid electrolyte particles can be synthesized.

### (b) Surface Treatment

The production method includes reducing crystallinity of at least a part of the surface of the solid electrolyte particle. For example, a damaged layer may be formed by applying mechanical energy to the surface of the particle. The damaged layer has low crystallinity with respect to the base material. The damaged layer may form the shell portion 12 of the core-shell structure. The base material excluding the damaged layer may form the core portion 11 having a core-shell structure.

For example, the solid electrolyte particles may be subjected to wet milling treatment. For example, the solid electrolyte particles may be ground in the presence of a solvent by a planetary ball mill. The solvent may include, for example, at least one selected from the group consisting of butyl butyrate, heptane, and tetralin. After wet milling treatment, the solvent may be dried off.

For example, media made of ZrO₂ (ground balls) may be used. The rotation speed of the planetary ball mill may be, for example, 200 to 250 rpm. The treatment time may be, for example, 1 hour or more. The treatment time may be, for example, 24 hours or less.

### Examples

### —Samples—

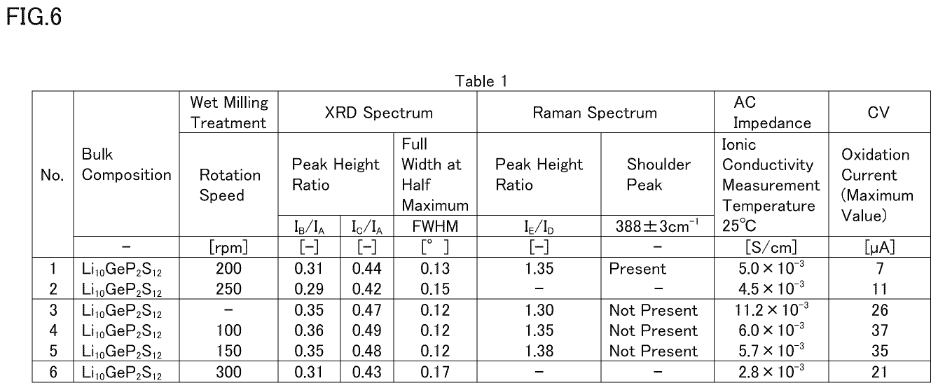

FIG. 6 is a table showing experimental results. Solid electrolyte particles according to Nos. 1 to 6 were produced by the following procedure.

### No. 1

The first mixture was prepared by mixing 3.902 parts by mass of Li₂S, 3.775 parts by mass of P₂S₅, and 2.323 parts by mass of GeS in a mortar until they were substantially uniform. A first pot (material: ZrO₂, volume: 500 mL) for a planetary ball mill and a first medium (material: ZrO₂, diameter: 5 mm) were prepared. 450 parts by mass of the first medium and the first mixture were charged into the first pot. Dry milling treatment was performed at a rotation speed of 300 rpm for 20 hours. Thus, a second mixture was prepared. The second mixture was formed into pellets. The pellets were enclosed in quartz tubes. The quartz tube was coated with carbon. The pellets were heat treated. The heat treatment temperature was 600° C. The heat treatment time was 6 hours. Thus, a solid electrolyte was synthesized. After the heat treatment, the pellets were ground to recover the solid electrolyte particles.

A second pot (material: ZrO₂, volume: 45 mL) for a planetary ball mill, a second medium (material: ZrO₂, diameter: 1 mm), and a third medium (material: ZrO₂, diameter: 0.1 mm) were prepared. 10 parts by mass of the second medium, 40 parts by mass of the third medium, 0.75 parts by mass of the solid electrolyte particles, and 6 parts by mass of butyl butyrate (solvent) were charged into the second pot. Wet milling treatment was carried out at a rotation speed of 200 rpm for 1 hour. After wet milling treatment, the solvent was removed by a drying operation.

### No. 2 to No. 6

As shown in the item of “wet milling treatment” in FIG. 6, solid electrolyte particles were produced in the same manner as in No. 1, except that the rotation speed in the wet milling treatment was changed. In No. 3, the wet milling treatment was not performed. No. 3 is a base material (unprocessed product).

### —Evaluation—

FIG. 1 shows XRD spectra of No. 1 to No. 6. Each of the samples has peaks at positions of 2θ=29.4±0.5°, 41.4±0.5°, and 47.3±0.5°. The peak height ratio (I_{B}/I_{A}) and (I_{C}/I_{A}) tend to decrease as the rotation speed of the wet milling treatment increases. This is considered to be because the crystallinity is lowered by the wet milling treatment.

FIG. 2 shows Raman spectra of No. 1, No. 3 to No. 5. In No. 1, a shoulder peak was clearly confirmed at a Raman shift of 388±3 cm⁻¹. The shoulder peak is considered to be derived from the impurity phase (Li₂S, etc.). It is considered that the impurity phase is generated by slightly decomposing the LGPS-type crystal phase by the wet milling treatment.

The difference in peak height ratio (I_{E}/I_{D}) between the samples is small. From this result, it is considered that the crystallinity of the bulk (symmetry of the LGPS-type structure) is hardly changed by the wet milling treatment. In the wet milling treatment, it is considered that crystallinity is locally lowered on the outermost surface of the particle.

FIG. 3 shows cyclic voltammograms of No. 1 to No. 6. As the rotation speed in the wet milling treatment increases, the peak of the oxidation current tends to decrease (No. 1 to No. 6). It is considered that oxidation resistance is imparted to the surface of the particles by the wet milling treatment. However, when the rotation speed in the wet milling treatment exceeds 250 rpm, the oxidation current increases again (No. 6). This is considered to be because the particles were broken. The destruction of the particles results in the formation of microparticles. It is considered that the oxidation reaction is promoted by an increase in the amount of the interface between the fine particles and the VGCF (conductive material).

FIG. 6 shows ionic conductivities of No. 1 to No. 6. Wet milling treatment tends to reduce ionic conductivity. However, a high ionic conductivity of the order of 10⁻³ S/cm is maintained.

From the above results, when the peak height ratio (I_{B}/I_{A}) in the XRD spectrum is 0.20 to 0.35 and the peak height ratio (I_{C}/I_{A}) is 0.30 to 0.45, improvement in oxidation resistance is expected.

### APPENDIX

In one aspect of the present disclosure, a method for producing a solid electrolyte particle is provided.

The method for producing a solid electrolyte particle includes the following (a) and (b):
(a) synthesizing a solid electrolyte particle including an LGPS-type crystal phase; and
(b) subjecting the solid electrolyte particle to a surface treatment, wherein
the surface treatment changes the LGPS-type crystal phase to an amorphous phase in at least a portion of a surface of the solid electrolyte particle.

The (b) may include subjecting the solid electrolyte particle to a wet milling treatment. The wet milling treatment may be performed using a planetary ball mill. A rotation speed of the planetary ball mill may be, for example, 200 to 250 rpm. A treatment time may be, for example, 1 hour or more.

What is claimed is:

1. A solid electrolyte particle comprising:
Li;
Ge;
P; and
S, wherein
the solid electrolyte particle satisfies relationships of the following formulas (1) and (2):
$$0.2 \leq {I}_{B} / {I}_{A} \leq 0.35 ; and \qquad ( 1 )$$
$$0.3 \leq {I}_{C} / {I}_{A} \leq 0 \text{.45} , \qquad ( 2 )$$
where
I_{A}, I_{B}, and I_{C} each indicate a peak height in an X-ray diffraction spectrum measured using a CuKα ray as an X-ray source,
I_{A} indicates a peak height at a diffraction angle of 29.4±0.5°,
I_{B} indicates a peak height at a diffraction angle of 41.4±0.5°, and
I_{C} indicates a peak height at a diffraction angle of 47.3±0.5°.

2. The solid electrolyte particle according to claim 1, wherein in the X-ray diffraction spectrum, the peak at a diffraction angle of 29.4±0.5° has a full width at half maximum of 0.15° or less.

3. The solid electrolyte particle according to claim 1, wherein
the solid electrolyte particle further satisfies a relationship of the following formula (3):
$$1.2 \leq {I}_{E} / {I}_{D} , \qquad ( 3 )$$
where
I_{D} and I_{E} each indicate a peak height in a Raman spectrum,
I_{D} indicates a peak height at a Raman shift of 420±10 cm⁻¹,
I_{E} indicates a peak height at a Raman shift of 360±10 cm⁻¹, and
the Raman spectrum has a shoulder peak at a Raman shift of 388±3 cm⁻¹.

4. The solid electrolyte particle according to claim 1, comprising:
a core portion; and
a shell portion, wherein
the shell portion covers a periphery of the core portion,
the core portion includes an LGPS-type crystal phase,
the shell portion includes an amorphous phase,
the core portion has an ionic conductivity of 10×10⁻³ S/cm or more, and
the shell portion has an ionic conductivity of 1×10⁻³ S/cm or less.

5. The solid electrolyte particle according to claim 4, wherein the shell portion has a thickness of 100 nm or less.
